(19) United States
(12) Patent Application Publication
(10) Pub. No.: US 2008/0251211 A1
(43) Pub. Date: Oct. 16, 2008

(54) Apparatus for producing corrugated cardboard

(75) Inventors: Toshimitsu Akiyama, Tokyo (JP); Tadashi Kasamatsu, Tokyo (JP)

Correspondence Address: KRATZ, QUINTOS & HANSON, LLP, 1420 K Street, N.W., Suite 400, WASHINGTON, DC, 20005, US

(73) Assignee: AIKI KOGYO KABUSHIKI KAISHA, Tokyo (JP)

(21) Appl. No.: 11/783,753

(22) Filed: Apr. 11, 2007

(51) Int. Cl. B31F 1/00

(52) U.S. Cl. 156/472

(57) ABSTRACT

Disclosed is a compact and convenient apparatus for producing corrugated cardboard, which solves or at least lightens the problem that the plant is too long. In this apparatus a component (I) for completing a single facer corrugated cardboard is disposed on the first floor (G); a component (II) for preparing incomplete corrugated card board on the second floor deck (U); a component (III) for obtaining the complete corrugated cardboard on the slope which goes down gradually and linearly from the second floor deck to the first floor; and a component (IV) for drawing the product corrugated cardboard and delivering to the next processing steps on the first floor.

### BACKGROUND OF THE INVENTION

1. Technical Field

The present invention concerns an apparatus for producing corrugated cardboard. The improvement offered by the present invention is compactness of whole the plant and easiness of handling the product corrugated cardboard for the subsequent processing steps by reasonable disposition of the components of the apparatus for producing corrugated cardboard.

2. Prior Art

The process for producing corrugated cardboard currently practiced in production of “single wall” product consisting of three layers comprises the following steps:
1) core-producing step by continuously supplying a core material sheet and processing it to form a corrugated core sheet;
2) first paste material-applying and paste-forming step by applying raw starch slurry on the tops of the corrugated core sheet, and heating the applied first paste material to convert a portion of it to gel:
3) single facer corrugated card board-producing step by continuously laminating a back liner material and the above-produced corrugated core sheet and heating the first paste material to accelerate gel-formation so that the adhesion of the two sheets may be complete and a single facer corrugated cardboard may be prepared:
4) second paste material-applying and paste-forming step by applying raw starch slurry on the tops of corrugates of the single facer corrugated cardboard thus prepared and heating the applied second paste material with a pre-heater having a heating roller so as to convert the second paste material to gel;
5) corrugated cardboard-preparing step by continuously laminating a front liner material and the single facer corrugated cardboard thus prepared;
6) corrugated cardboard-completing step by continuously bringing the front liner into contact with heating plates to heat the second paste material so as to accelerate gel-formation for complete adhesion; and
7) processing-preparation step consisting of withdrawing the complete corrugated cardboard under cooling and carrying out necessary provisional treatment such as cutting and stacking.

The corrugated cardboard consisting of five layers called “double wall” is manufactured by stacking and adhering two above-mentioned single facer corrugated cardboards and a front liner material. In this case, in order to satisfy the mechanical properties required to the double wall corrugated cardboard, it is general to use a corrugated cardboard having relatively large corrugation called “A-flute” as the first single facer and the other having relatively small corrugation called “B-flute” as the second single facer.

The corrugated cardboard thus manufactured is, either the single wall or the double wall, continuously withdrawn and usually cut to pieces of suitable length and delivered in the stacked form. Sometimes, however, the product may be further processed by in-line processing such as printing, punching or box-making.

Of the technical problems residing in the corrugated cardboard production the most important is improvement in productivity, i.e., achievement of higher line speed, and this requirement is forever. The single wall product of the A-flute, which is the popular one produced with the highest productivity, can be produced at the line speed of maximum 400 meter per minute. The problem second to this is that concerning the quality of the product, such as no curing or clean surfaces.

The inventor, having made efforts in improvement in technology of corrugated cardboard production for many years, developed some technologies relating to both increase in the line speed and improvement in the product quality. One of the important developments is use of high temperature dry steam prepared by reheating low pressure steam as the heat source of converting water dispersion of starch powder (hereinafter referred to as “raw starch slurry”) applied on the tops of the corrugation (Japanese Patent Publication Sho.59-015066 and Hei.03-065365), and the other is the technology of blowing steam to the core sheet to moisten and heat it prior to application of the raw starch slurry (Japanese Patent Publication Hei.04-074181). He also disclosed another technology of moistening and heating the liner materials (Japanese Patent Publication Hei.06-011521).

In the above-noted technologies the apparatus for moistening is called “moistener”, and the apparatus for heating (and also moistening to some extent), “steamer”. The moistener has function of effecting steam of normal pressure and not so high temperature to the material of corrugated cardboard in the process of manufacturing for the purpose mainly of giving moist to the material so as to facilitate processing the core material to corrugated form, and to prevent excess absorption of water in the applied paste material by the core sheet at rapid rate and in large quantity. On the other hand, the steamer has the main purpose of blowing the heated and somewhat high temperature steam to heat the applied paste material for converting it to gel.

Recent proposal by the inventor is the technology of corrugated cardboard production, in which heating with the conventional heating plates is eliminated. The advance by the new technology is that, in producing decorative corrugated cardboards, surface scratch caused by friction between the board and the heating plates can be avoided in principle. The elimination of the heating plates was realized by preheating the material sheets and full utilization of the moisteners and the steamers (Japanese Patent Disclosure 2006-218841). Another advance is adoption of curing step during which the paste material permeates well and heating of the permeated paste material with superheated steam, instead of heating with the heating plates, to accelerate conversion to gel (Japanese Patent Disclosure 2007-30171).

From the viewpoint of plant formation of the apparatus for producing corrugated cardboard, it is a problem that the components carrying out the above-mentioned corrugated cardboard completion step (step 6) and the subsequent processing-preparation step (step 7) are very long and large. In a typical plant the array of the above-mentioned heating plates is 10 meter long, and the subsequent cooling canvas is at least 10 meter long. Addition of the other components of the plant necessary for the corrugated cardboard production to the above-discussed components results in a whole plant of 90 meters or longer. Based on the practical problem that possible space of building is usually limited, it is desirable that the apparatus for producing corrugated cardboard is more compact.

The problem that the plant is long and large is particularly significant in the technology of producing corrugated cardboard, in which use of the heating, plates is eliminated, proposed by the inventor (the above-mentioned Japanese Patent Disclosure 2006-218841). In the embodiment or utilizing heating with superheated steam instead of the heating plates (the above-mentioned Japanese Patent Disclosure 2007-30171), the period necessary for holding the incomplete corrugated cardboard in the laminated state is somewhat shorter, and therefore, the apparatus for holding the material is not so long and large. However, the whole plant is still long enough that requires some remedy.

The completed corrugated cardboard may be further processed by subsequent in-line processing steps. In general, however, it is easy to practice the steps for corrugated cardboard production and the subsequent steps separately, and therefore, it is often practiced to cut the product into pieces of a certain size and the certain number of thus obtained pieces of the determined size are stacked, and the stacks are delivered to the subsequent steps such as box-making. For this purpose, it will be inconvenient for operation, if the product corrugated cardboards are not placed in the position near the floor level. Thus, it is usual that the steps after lamination of the single facer and the front liner material are carried out on the floor level of the plant. Typical distribution of the apparatus components is as shown in FIG. 1. FIG. 1 illustrates an apparatus for producing “single wall” corrugated card board.

### SUMMARY OF THE INVENTION

The object of the present invention is to solve the above discussed problem that whole the plant will be long and large and to provide a compact and easy-to-operate apparatus for producing corrugated cardboard, which begins with preparation of the single facer corrugated cardboard to go to lamination of it with a front liner material, and to eliminate the step of carry down the product corrugated cardboard.

The apparatus for producing corrugated cardboard according to the present invention comprises, as shown in whole in FIG. 2 and in detail in FIGS. 3 and 4, comprises the first floor (G) and second floor deck (U) thereon, and the following components:
(I) a component for processing the core material to the corrugated core, continuously laminating the corrugated core and a back liner material with a paste to form a single facer corrugated cardboard:
(II) a component for continuously laminating the single facer corrugated cardboard and the front liner material with paste to form an incomplete corrugated cardboard;
(III) a component for obtaining completed corrugated cardboard by heating the incomplete corrugated cardboard to complete adhesion with the paste; and
(IV) a component for cutting the obtained complete corrugated cardboard into pieces, stacking the pieces and delivering the stack for subsequent processing steps;
   and is characterized in that the components (I) and (IV) are disposed on the first floor, the component (II) on the second floor deck, and the component (III) on the slope which goes down gradually and linearly from the second floor deck to the first floor.

### BRIEF EXPLANATION OF THE DRAWINGS

FIG. 1 illustrates outline of whole the structure of a conventional apparatus for producing “single wall” corrugated cardboard along the line of the material flow;

FIG. 2 illustrates outline of whole the structure of the apparatus for producing “single wall” corrugated cardboard according to the present invention also along the line of the material flow;

FIG. 3 is a side elevation view of an apparatus for producing “double wall” corrugated cardboard according to the present invention showing the former part of the apparatus along the line of the material flow; and FIG. 4, the latter part of the apparatus also along the line of the material flow;

FIGS. 5 and 6 illustrate the superheated steam-blowing nozzles and related devices used in the apparatus according to the invention, FIG. 5 is a plan view, and FIG. 6, a side view in which a portion is cut off;

FIG. 7 is a map showing changes in temperatures in case of double wall corrugated cardboard production using the present apparatus at positions “a,”, “a′”, “b” and “c”; and

FIG. 8 is a graph showing the temperatures in FIG. 7.

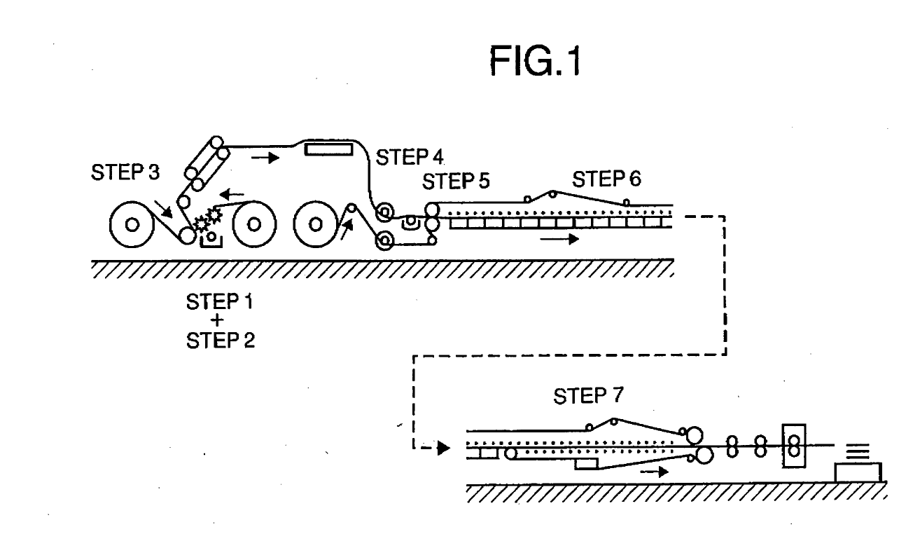

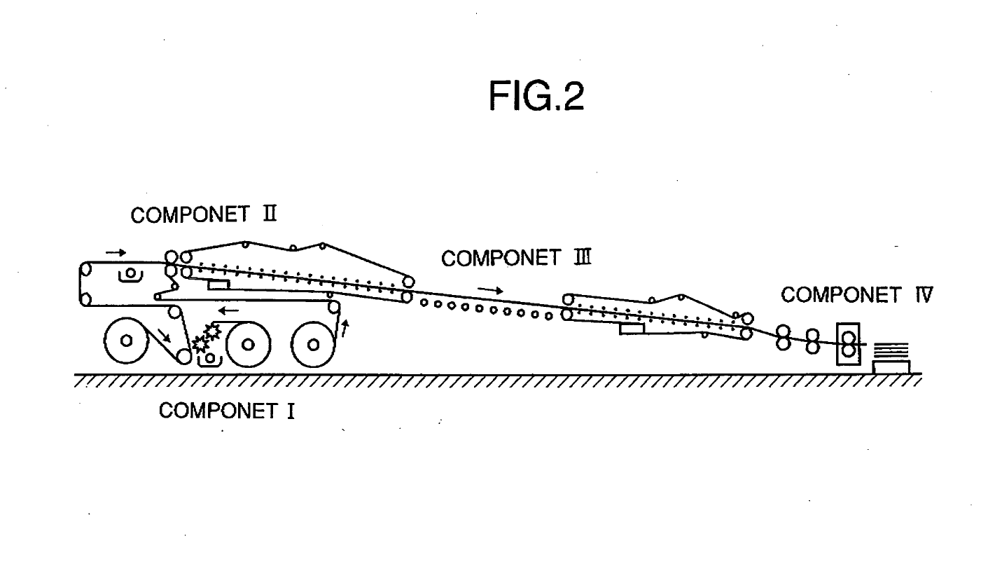

### DETAILED EXPLANATION OF THE PREFERRED EMBODIMENTS

The following explains the apparatus for producing corrugated cardboard according to the invention in detail. The respective components of the apparatus comprise the elements described below:

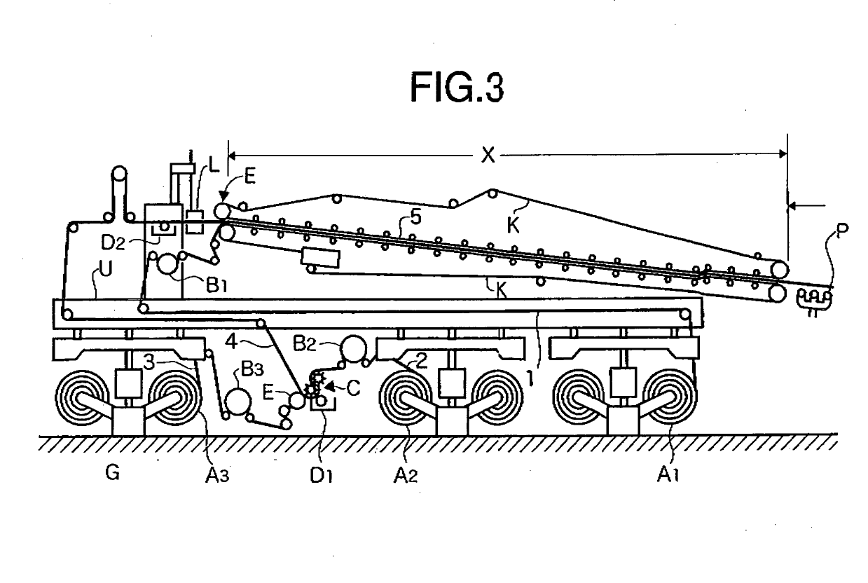

The component (I) for processing the core material to the corrugated core, continuously laminating the corrugated core and a back liner material with a paste to form a single facer corrugated card board comprises, in a preferred embodiment, as shown in FIG. 3,
means (A2) for continuously supplying the core material,
a core material-preheating roller (B2) for preheating the supplied core material,
a pair of tooth formed rollers (C) for continuously processing the preheated core material to the corrugated core,
first means (D1) for supplying paste material to apply raw starch slurry on the tops of the corrugates of the corrugated core,
means (A3) for continuously supplying the back liner material,
a back liner-preheating roller (B3) for preheating the supplied back liner material, and
pressing roller (E) fox continuously laminating the preheated back liner material and the corrugated core on which the first paste material is applied to form the single facer corrugated cardboard (4).

Then, the component (II) for continuously laminating the single facer corrugated cardboard and the front liner material with paste to form an incomplete corrugated cardboard to form an incomplete corrugated cardboard comprises, in a preferred embodiment, as also shown in FIG. 3,
means (A1) for continuously supplying the front liner material,
   which is disposed on the ground floor (G), and
second means (D2) for supplying paste material to apply raw starch slurry on the tops of the corrugates of the single facer corrugated cardboard (4),
steamer (L) for blowing superheated steam on the second paste material (9) to half-gel it,
front liner material-preheating roller (B1) for preheating the supplied front liner material, and
a pair of pressing roller (E) for continuously laminating the single facer corrugated cardboard and the front liner material to form an incomplete corrugated card board,
   which are disposed on the second floor deck (U).

The component (III) for obtaining completed corrugated cardboard by heating the incomplete corrugated cardboard to complete adhesion with the paste comprises, in a preferred embodiment, as shown in FIG. 4.
a curing zone (Z), which is the zone for letting the incomplete corrugated cardboard (S) run under keeping the state of lamination and having the half-gelled second paste material permeated into the core corrugate and the front liner, having a plural pairs of rollers and a pair of canvases (K) facing to each other and running between the rollers,
a heating zone (Y), which is the zone for blowing the superheated steam on the front liner side of the incomplete corrugated cardboard (5) so as to fully gel the permeated second paste material with the heat and complete the adhesion, having plural nozzle (P) for blowing the superheated steam installed under the running incomplete corrugated cardboard, and
a cooling zone (Z), which is the zone for drawing the complete corrugated card board (5C) under cooling, having plural pairs of rollers and a pair of canvases (K) facing to each other and running between them.

The component (IV) for cutting and stacking to deliver the product to subsequent processing steps comprises, as also shown in FIG. 4,
a cutter (R) for cutting the complete double facer corrugated card board in regular size pieces, and
a stacker (S) for stacking the cut double facer corrugated card board pieces.

Usually, the component is equipped with a roller conveyer to deliver the stacked corrugated cardboard pieces to the next processing steps.

Alternatively, in such cases as mass-production of boxes of the same size, an in-line punching device for punching the produced double facer corrugated cardboard to determined shapes and sizes may be installed instead of the cutter and the stacker. The component (IV) of the present invention may include such an embodiment.

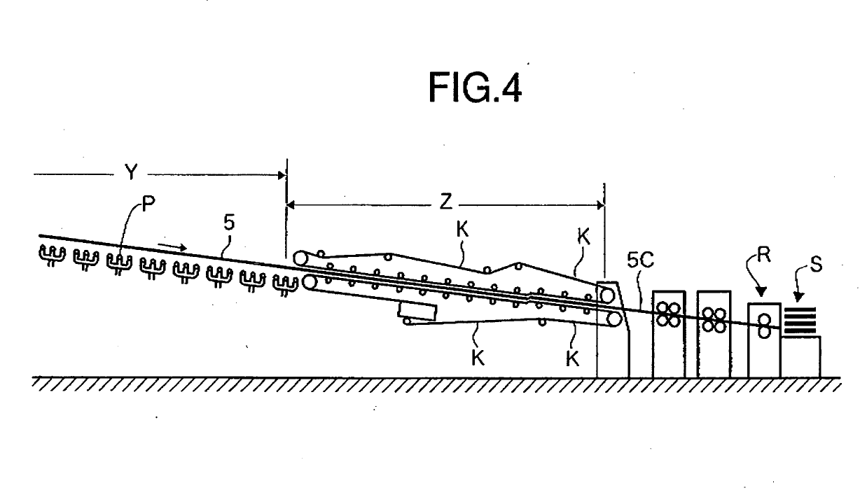

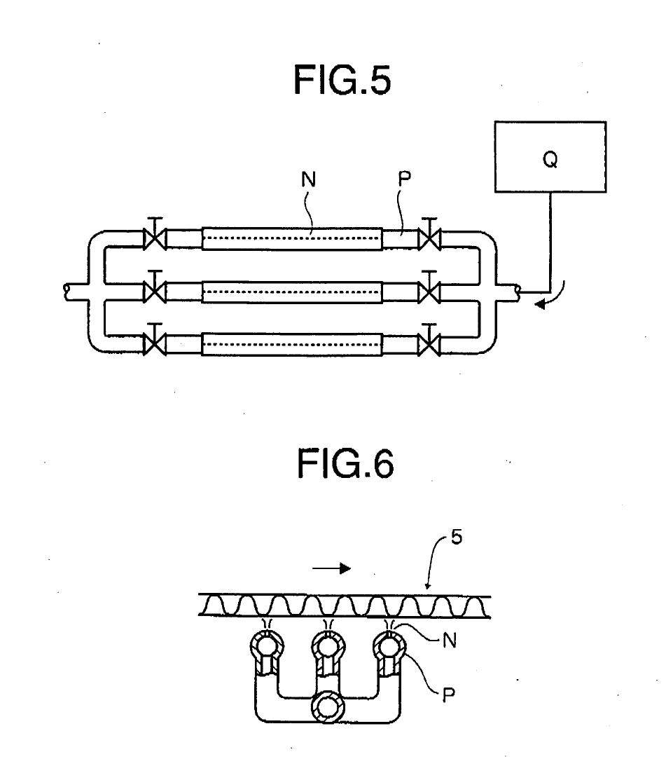

The superheated steam-blowing nozzles (P) disposed in the heating zone (Y) and the accessories thereof are disclosed in detail in the above-mentioned Japanese Patent Disclosure 2007-30171. They are, however, shown in FIG. 5 and FIG. 6.

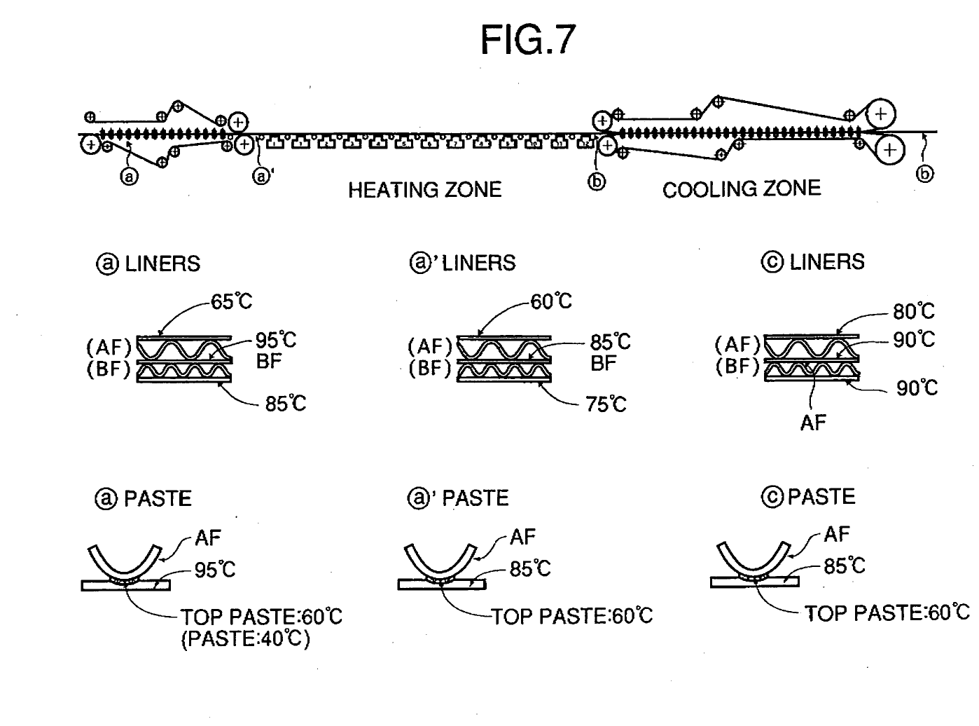

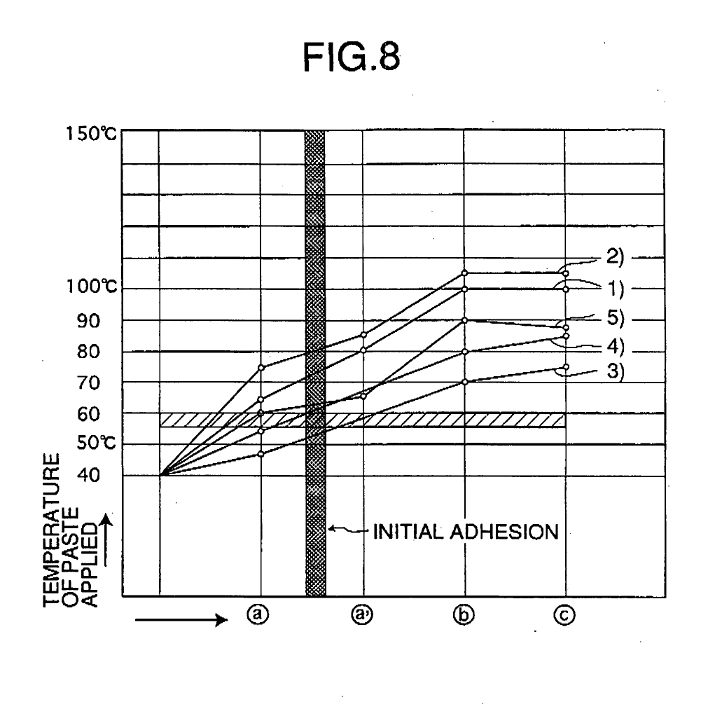

FIG. 7 shows changes in the temperature at the positions “a”, “a′”, “b” and “c”; and of the present apparatus in which the double wall corrugated card board is being manufactured. The graph of FIG. 8 shows the above temperature changes for better understanding. In this graph the following five series of data are shown for comparison;
1) in case of producing a single wall corrugated cardboard (AF: A-Flute) in a conventional apparatus having only the heating plates, temperature of the paste material between the tops of the corrugates and the front liner;
2) in case of producing a single wall corrugated cardboard (AF) in a conventional apparatus having the heating plates, to which the steamer invented by the present inventor is added, temperature of the above-mentioned paste material;
3) in case of producing a double wall (AF+BF: A-Flute+B-Flute) corrugated cardboard with a conventional apparatus having only the heating plates, the temperature of the paste material between the tops of the corrugates of AF and the internal liner (liner of the BF);
4) in case of producing a double wall (AF+BF) corrugated cardboard with a conventional apparatus having the heating plates, to which the steamer invented by the present inventor is added, the temperature of the paste material between the tops of the corrugates of AF and the internal liner (liner of the BF);
5) in case of producing a double wall (AF+BF) corrugated cardboard with the apparatus according to the present invention, in which the heating plates are eliminated and blowing the superheated steam is adopted, the temperature of the paste material between the tops of the corrugates of AF and the internal liner (liner of the BF).

As shown in the graph of FIG. 8, the temperature at which gelling of the raw starch slurry occurs is in the range of about 58-63° C. Even if the temperature reached to, or exceeded this level, the rate of gelling is quicker at a higher temperature and slower at a lower temperature. It is, therefore, necessary to have the temperature of the raw starch slurry applied on the tops of corrugates increased to the above gelling temperature as quick as possible, and further, to a higher temperature as quick as possible. However, there is a problem that drying of the raw starch slurry at only the surface thereof caused by rapid heating results in film formation on the gelled paste material and the film disturbs adhesion. In addition, the drying gives, in relation to the rate and extent of permeation of the slurry, the following limitation.

If the internal core (corrugated material) has high water-absorbing property, only the water in the raw starch slurry applied is absorbed by the paper, and as the result, water content of the paste material becomes insufficient and gelling or paste formation is not appropriately realized. Thus, desired adhesive power cannot be obtained. (adhesion under insufficient paste formation) On the other hand, if the core is of low water-absorbing property, then permeation of the raw starch slurry into the core is difficult, and the result of this is one-side gelling and adhesion occurs under the condition that the paste resides only on the surface. (adhesion of surface only)

The latter phenomenon tend to occur in the case where a strongly sized paper called “reinforced internal core” is chosen as the internal core of the AF with the intention to strengthen the double wall corrugated cardboard. Such a trouble is often experienced in cases where the corrugated cardboard just after a couple of hours since production, which apparently seems completely adhered, is handled with hands. The product may easily decompose into sheets with terrible noise. Only when the permeation of the raw starch slurry is appropriate and it is properly gelled, desirable adhesion (permeation adhesion) may be achieved.

It will be understood from the graph of FIG. 8 that, in case where a double wall corrugated cardboard is produced using the apparatus according to the present invention, temperature increase is slow in the curing zone from point “a” to point “a′”, during which permeation of the raw starch slurry proceeds well, and in the heating zone from point “a′” to point “b”, rapid temperature increase is caused by blowing of superheated steam. The present invention enables rapid galling in the heating zone resulting in complete adhesion.

Because the apparatus for producing corrugated cardboard according to the present invention eliminates use of heating plates, this apparatus can be conveniently used for production of so-called decorative corrugated cardboard. In that case, one or more of apparatus for carrying out the decorative printing or processing on the front liner material, such as that selected from the group of flexo-printer, gravure-printer, and embossing press (none of them are shown in the drawings) as desired. These apparatus may be usually installed on the first floor near the means for supplying the front liner material.

1. An apparatus for producing corrugated cardboard, which comprises the first floor (G) and the second floor deck (U), and the following components:
(I) a component for processing a core material to the corrugated core, continuously laminating the corrugated core and a back liner material with a paste to form a single facer corrugated cardboard;
(II) a component for continuously laminating the single facer corrugated cardboard and a front liner material with the paste to form an incomplete corrugated cardboard:
(III) a component for obtaining completed corrugated cardboard by heating the incomplete corrugated cardboard to complete adhesion with the paste; and
(IV) a component for cutting the obtained complete corrugated card board into pieces, stacking the pieces and delivering the stack for subsequent processing steps;
and is characterized in that the components (I) and (IV) are disposed on the first floor (G), the component (II) on the second floor deck (U), and the component (III) on the slope which goes down gradually and linearly from the second floor deck to the first floor.

2. The apparatus according to claim 1, wherein the component (I) for processing a core material to the corrugated core, continuously laminating the corrugated core and a back liner material with a paste to form a single facer corrugated cardboard comprises:
means (A2) for continuously supplying the core material,
a core material-preheating roller (B2) for preheating the supplied core material,
a pair of tooth form rollers (C) for continuously processing the preheated core material to the corrugated core,
first means (D1) for supplying paste material to apply raw starch slurry on the tops of the corrugates of the corrugated core,
means (A3) for continuously supplying the back liner material,
a back liner-preheating roller (B3) for preheating the supplied back liner material, and
pressing roller (E) for continuously laminating the preheated back liner material and the corrugated core on which the first paste material is applied to form the single facer corrugated cardboard (4).

3. The apparatus according to claim 1, wherein the component (II) for continuously laminating the single facer corrugated cardboard and a front liner material with the paste to form an incomplete corrugated cardboard comprises:
means (A1) for continuously supplying the front liner material,
which is disposed on the ground floor (G), and
second means (D2) for supplying paste material to apply raw starch slurry on the tops of the corrugates of the single facer corrugated cardboard (4),
steamer (L) for blowing superheated steam on the second paste material (9) to half-gel it,
front liner material-preheating roller (E1) for preheating the supplied front liner material, and
a pair of pressing roller (E) for continuously laminating the single facer corrugated cardboard and the front liner material to form an incomplete corrugated card board,
which are disposed on the second floor deck (U).

4. The apparatus according to claim 1, wherein the component (III) for obtaining completed corrugated cardboard by heating the incomplete corrugated cardboard to complete adhesion with the paste comprises:
a curing zone (Z), which is the zone for letting the incomplete corrugated cardboard (5) run under keeping the state of lamination and having the half-gelled second paste material permeated into the core corrugate and the front liner, having a plural pairs of rollers and a pair of canvases (K) facing to each other and running between the rollers,
a heating zone (Y), which is the zone for blowing the superheated steam on the front liner side of the incomplete corrugated cardboard (5) so as to fully gel the permeated second paste material with the heat and complete the adhesion, having plural nozzle (P) for blowing the superheated steam installed under the running incomplete corrugated card board, and
a cooling zone (Z), which is the zone for drawing the complete corrugated card board (5C) under cooling, having plural pairs of rollers and a pair of canvases (K) facing to each other and running between them.

5. The apparatus according to claim 1, wherein the component (IV) for cutting the obtained complete corrugated cardboard into pieces, stacking the pieces and delivering the stack for subsequent processing steps comprises:
a cutter (R) for cutting the complete double facer corrugated cardboard in regular size pieces, and
a stacker (S) for stacking the cut double facer corrugated cardboard pieces.
